(19) United States
(12) Patent Application Publication
(10) Pub. No.: US 2025/0101802 A1
(43) Pub. Date: Mar. 27, 2025

(54) Area Screen with Screen Door

(71) Applicant: Screen America Corporation, HOMOSASSA, FL (US)

(72) Inventor: Richard Charles Smith, Jr., Sarasota, FL (US)

(73) Assignee: Screen America Corporation, HOMOSASSA, FL (US)

(21) Appl. No.: 18/475,234

(22) Filed: Sep. 27, 2023

(51) Int. Cl. E06B 9/54; E06B 9/70

(52) U.S. Cl. CPC E06B 9/54; E06B 9/70

(57) ABSTRACT

A screen system includes a screen mesh and a spool. The spool is rotatably mounted to a frame of the opening and the screen mesh is affixed to the spool such that the spool retracts or deploys the screen mesh over the opening. There is a mechanism for turning the spool (e.g., a motor or hand crank). A screen door is formed in the screen mesh such that sides of the screen door are at an angle other than 90 degrees to the spool. Zipper teeth around a periphery of the screen door and the opening for the screen door have a zipper pull that traverses the zipper teeth in a first direction to disconnect the screen door from the opening for gaining access to/from the opening and the zipper pull traverses the zipper teeth in a second direction, opposing the first direction, for closing the screen door.

### BACKGROUND OF THE INVENTION

Large area screen systems are well known. Some large area screen systems are stationary, having screen mesh mounted to frames such as aluminum or wood frames as are found in screen enclosures. As these styles of large area screen systems have frames, it is relatively easy to include a door frame and a screen door.

Some large area screen systems retract. These large area screen systems have a roller (mechanically operated or motor operated) that revolves in one direction to retract the screen mesh and in the opposing direction to deploy the screen mesh. These retractable large area screen systems are often used to seal a large opening such as a garage door, a warehouse door, or a hangar door. By deploying the screen mesh to cover such openings, small animals and insects are prevented from entering the protected space while people inside have access to air circulating through the retractable screen mesh. In order to be effective, such large area screens must cover the entire opening to the garage, hangar, etc., otherwise unwanted animals or insects would be free to enter the protected area. Unfortunately, when the screen mesh is deployed and covers the entire opening, if a person needs to enter or exit the protected area, the person must retract the entire screen, or bend the screen mesh at a side to enter or exit, the latter often damaging the screen mesh. Therefore, it is advantageous to provide a door for such screen systems, typically a screen door that can be zipped open and then zipped close after entry/exit. Unfortunately, the screen mesh is very thin compared to the thickness of the teeth of a zipper and the zipper pull. When such a screen system is retracted around a roller, this extra thickness causes uneven wrapping and, therefore, potential for stretching or tearing of the screen mesh, especially in areas around the zipper.

What is needed is a retractable screen system that will provide access to the protected area and retracts evenly onto a roller.

### SUMMARY OF THE INVENTION

In one embodiment, a screen system is disclosed including a screen mesh for protecting an opening and a spool. The spool is rotatably mounted to a frame of the opening in a horizontal direction and the screen mesh is affixed to the spool such that the spool selectively retracts the screen mesh from the opening by rotating in a first rotational direction or deploys the screen mesh over the opening by rotating in a second rotational direction that is opposite to the first rotational direction. There is a mechanism for turning the spool (e.g., a motor or hand crank) to selectively retract or deploy the screen mesh. A screen door is formed in the screen mesh such that sides of the screen door are at an angle other than 90 degrees to the spool. Zipper teeth around a periphery of the screen door and the opening for the screen door have a zipper pull that traverses the zipper teeth in a first direction to disconnect the screen door from the opening for gaining access to/from the opening and the zipper pull traverses the zipper teeth in a second direction, opposing the first direction, for closing the screen door.

In another embodiment, a screen system is disclosed. The screen system is for protecting an area framed by a header that runs horizontal with respect to earth, a first riser at a first end of the header that runs substantially perpendicular to the header and second riser at a second, opposite end of the header that also runs substantially perpendicular to the header, The screen system includes a screen mesh for protecting the area and a spool. The spool is rotatably mounted between the first riser and the second riser parallel to the header. The screen mesh is affixed to the spool such that rotating of the spool selectively retracts the screen mesh by rotating in a first rotational direction or deploys the screen mesh by rotating in a second rotational direction that is opposite to the first rotational direction. A motor is interfaced between either of the first riser or the second riser and the spool for rotating the spool. A screen door is formed in the screen mesh such that sides of the screen door are at an angle other than 90 degrees to the header. Zipper teeth are around a periphery of the screen door and opening for the screen door such that a zipper pull traverses the zipper teeth in a first direction to disconnect the screen door from the opening for gaining access to/from the opening and the zipper pull traverses the zipper teeth in a second direction, opposing the first direction, for closing the screen door. The motor deploys the screen mesh by selectively rotating the spool in a first direction of rotation and the motor retracts the screen mesh by selectively rotating the spool in a second direction of rotation that is opposite of the first direction of rotation.

In another embodiment, a screen system is disclosed. The screen system is for protecting a garage opening that is framed by a header that runs horizontal to earth, a first riser at a first end of the header that runs substantially perpendicular to the header and second riser at a second, opposite end of the header that also runs substantially perpendicular to the header. The screen system includes a screen mesh for protecting the garage opening and a spool. The spool is rotatably mounted between the first riser and the second riser parallel to the and adjacent to the header. The screen mesh is affixed to the spool such that rotating of the spool selectively retracts the screen mesh by rotating in a first rotational direction or deploys the screen mesh by rotating in a second rotational direction that is opposite to the first rotational direction. A motor is provided for rotating the spool. The motor is interfaced between either the first riser or the second riser and the spool. A screen door is formed in the screen mesh having sides that are formed at an angle other than 90 degrees to the header. Zipper teeth are affixed around a periphery of the screen door and opening for the screen door such that when a zipper pull traverses the zipper teeth in a first direction to disconnect the screen door from the opening for gaining access to/from the opening and when the zipper pull traverses the zipper teeth in a second direction, opposing the first direction, for closing the screen door. The motor deploys the screen mesh by selectively rotating the spool in a first direction of rotation and the motor retracts the screen mesh by selectively rotating the spool in an opposite direction of rotation.

### BRIEF DESCRIPTION OF DRAWINGS

The invention can be best understood by those having ordinary skill in the art by reference to the following detailed description when considered in conjunction with the accompanying drawings in which:

FIG. 1 illustrates an elevational view of a screen system of the prior art.

FIG. 2 illustrates an elevational view of a screen system with a screen door in the closed configuration.

FIG. 3 illustrates an elevational view of the screen system with the screen door in the opened configuration.

FIG. 3A illustrates an elevational view of the screen system in a retracted configuration.

FIG. 4 illustrates an elevational view of the screen system with a second layout of screen door in the closed configuration.

FIG. 5 illustrates an elevational view of the screen system with the second layout of screen door in the opened configuration.

FIG. 6 illustrates an elevational view of the screen system with a third layout of screen door in the closed configuration.

FIG. 7 illustrates an elevational view of the screen system with the third layout of screen door in the opened configuration.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

In all examples below, the screen systems 100/200/200A are shown mounted in a garage door frame 150/152 as an example of where such screen systems 100/200/200A are often installed, but not limiting the invention to any particular opening as it is fully anticipated that the screen system 200/200A with a screen door be installed to cover any opening (when deployed), including, but not limited to, porches, warehouse doors, and hangar doors.

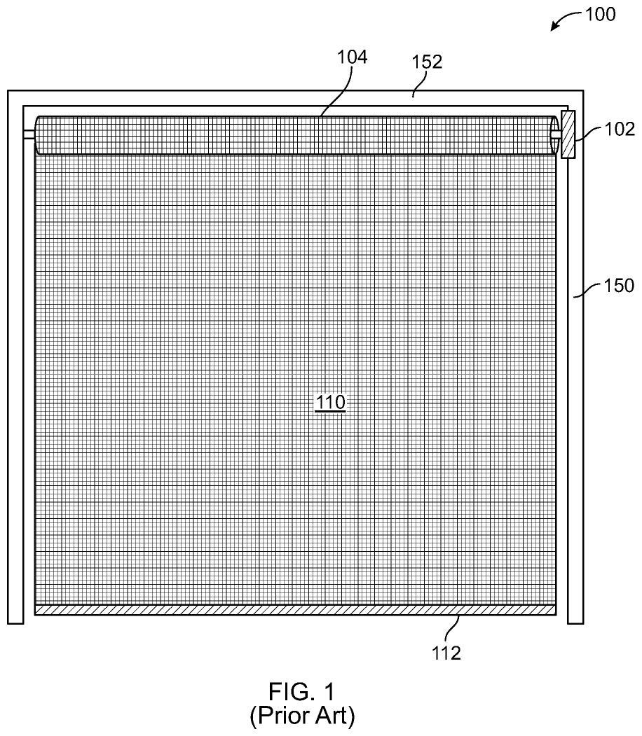

Referring to FIG. 1, an elevational view of a screen system 100 of the prior art is shown. In such, the screen system 100 of the prior art is shown deployed and, therefore, the screen mesh 110 occludes the opening to the garage. When the screen system 100 of the prior art is deployed, it is very difficult to gain entry (or exit) the protected area being that the screen mesh 110 completely covers the opening between the garage door header 152, risers 150 and floor of the protected area.

The screen mesh 110 is shown fully deployed from the spool 104 that is supported by a pin 106 at one end and a deployment mechanism 102 at an opposing end. The deployment mechanism is either a mechanical device (e.g., hand cranked) or an electro-mechanical device (e.g., motor driven).

When the screen mesh 110 is deployed, a mass 112 at an end of the screen mesh 110 reduces movement of the screen mesh 110 (e.g., when air movement occurs) and helps the screen mesh 110 roll up evenly on the spool 104 as the spool 104 rotates to retract the screen mesh 110.

It should be noted that should one implement a screen door with sides of the door roughly perpendicular to the spool 104, the screen mesh will not properly wrap around the spool when the screen mesh 110 is retracted (rolled onto the spool 104) as the zipper structure is substantially thicker than the screen mesh 110. In such, as the screen mesh 110 and zipper structure is rolled onto the spool 104, the thicker zippers will overlap each revolution of the spool 104, stretching and/or tearing the screen mesh 110 in an area around the screen door.

To solve the problems of the prior art, the disclosed screen system with a screen door 200 uses a zipper mechanism 201/202 that does not have a vertical zipper section and, therefore, the thickness buildup of the zipper mechanism 201/202 is evenly spread out over a wide area of the roller and there is little overlap of the zipper mechanism 201/202 and, therefore, minimal bulging caused by buildup of the zipper mechanism 201/202 as the screen mesh 210 and zipper mechanism 201/202 are wound around the spool 104.

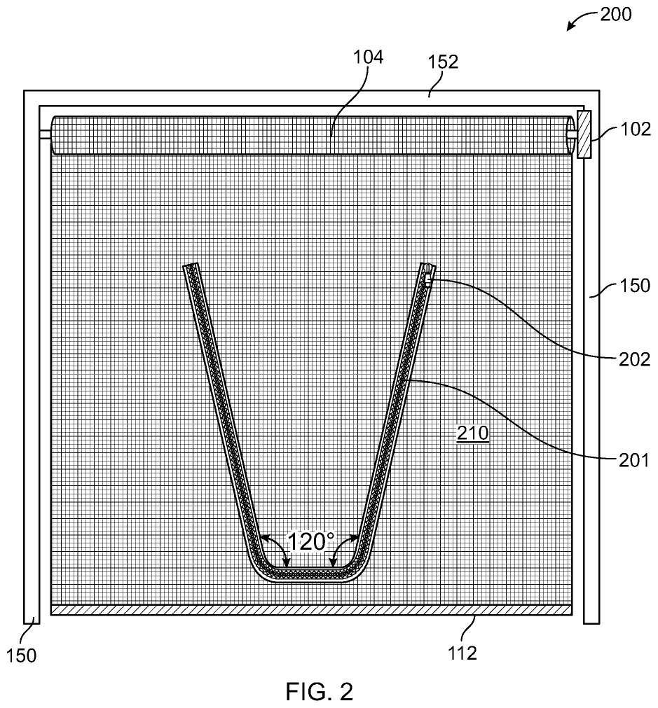

Note that in the examples shown in FIGS. 2, 3, 3A, 4, and 5, certain screen door shapes are shown as examples and there is no limitation as to the overall shape of the screen door. For example, it is fully anticipated that a circular screen door be formed to allow entry/exit of pets. The only restriction is that the zipper teeth 201 do not overlap themselves when the screen mesh 210 is wound around the spool 104.

Additionally, there is no restriction as to the material used as the screen mesh 210, as it is fully anticipated that other materials be used that are more or less porous, for example, but not limited to, cloth, fabric, plastic fence material, etc.

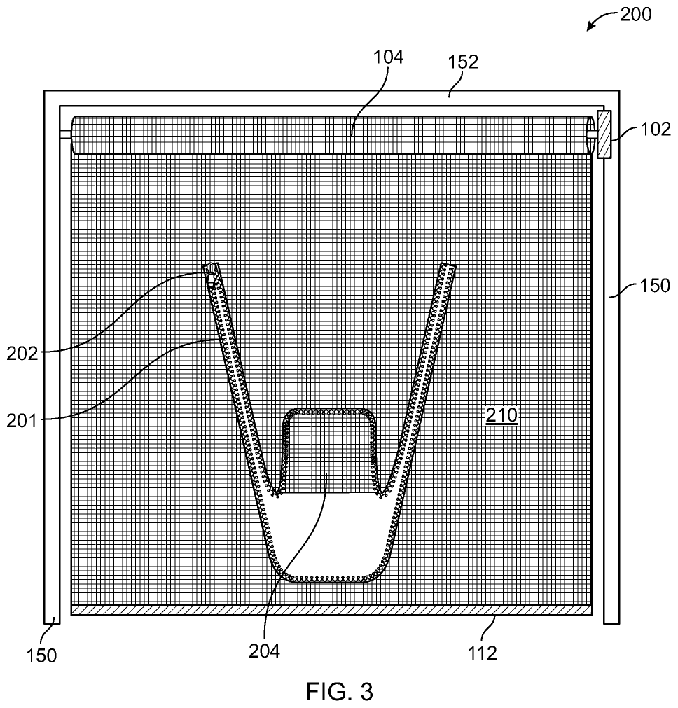

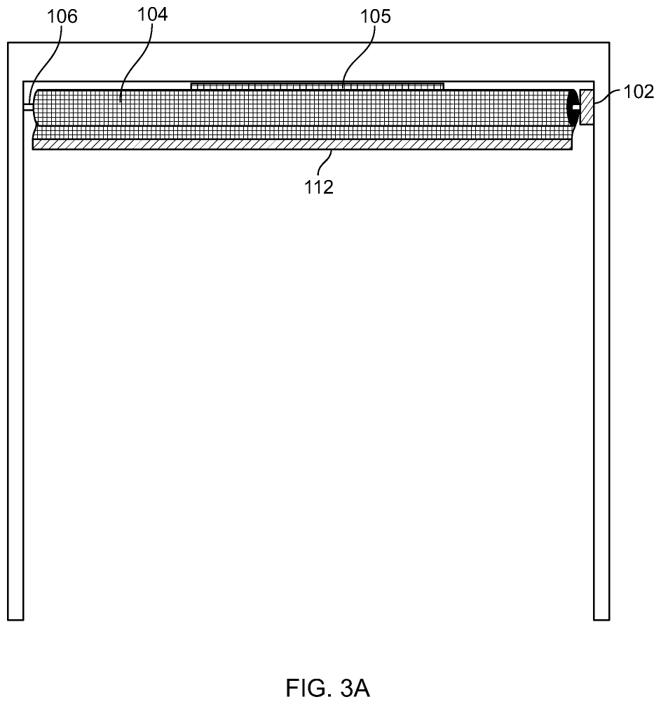

Referring to FIGS. 2, 3, and 3A, elevational views of a screen system with screen door 200 are shown. The screen door is shown in the closed configuration in FIG. 2 and in the opened configuration in FIG. 3. The screen mesh 210 is shown in the deployed configuration in FIGS. 2 and 3 and in the retracted configuration (e.g., wound around the spool 104) in FIG. 3A.

Although any shape of screen door is anticipated as long as no side of the screen door runs at 90-degrees from horizontal, the screen door shown in FIGS. 2 and 3 is in the shape of a flattened-V in which the bottom portion of the flattened-V shaped screen door is substantially horizontal and each side of the flattened-V shaped screen door is at approximately 120 degrees with respect to the bottom portion of the flattened-V shaped screen door.

In such, the screen system with screen door 200 is shown deployed in FIGS. 2 and 3 and, therefore, the screen mesh 210 occludes the opening into which the screen system with a screen door 200 is installed (e.g., between garage door risers 150 on the sides, a garage door header 152 at the top and a floor of the garage at the bottom). When the screen system with screen door 200 is deployed, entry (or exit) of the protected area is provided by a door or opening formed in the screen mesh 210.

The screen mesh 210 is shown fully deployed from the spool 104 that is supported by a pin 106 at one end and a deployment mechanism 102 at an opposing end. The deployment mechanism is either a mechanical device (e.g., hand cranked) or an electro-mechanical device (e.g., motor driven). Note that throughout this description, horizontal is defined as the direction in which the spool 104 is mounted (e.g., left-to-right), as for proper winding of the screen mesh 210 around the spool 104, the spool must be substantially in the horizontal plane, otherwise the screen mesh 210 will not wind around the spool 104 in an even fashion.

When the screen mesh 210 is deployed, a mass 112 at an end of the screen mesh 210 reduces movement of the screen mesh 210 (e.g., when air movement occurs) and helps the screen mesh 210 roll up evenly on the spool 104 as the spool 104 rotates to retract the screen mesh 210.

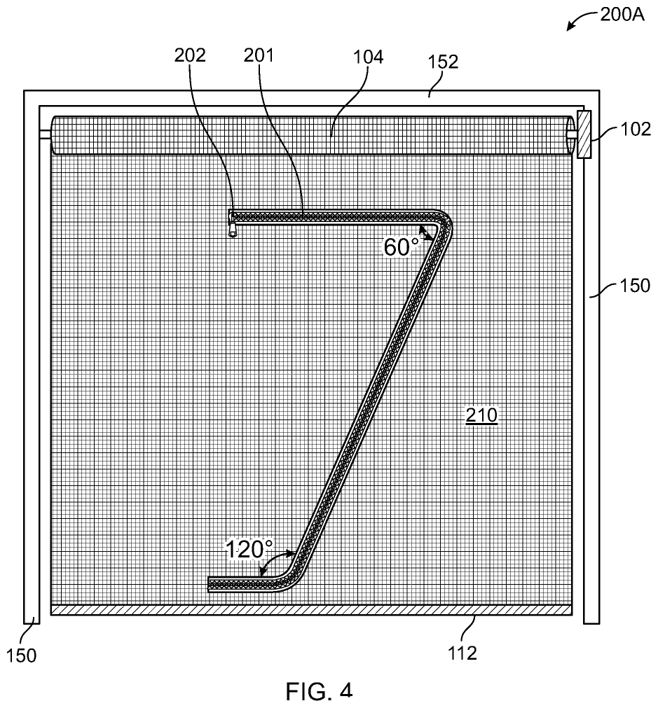

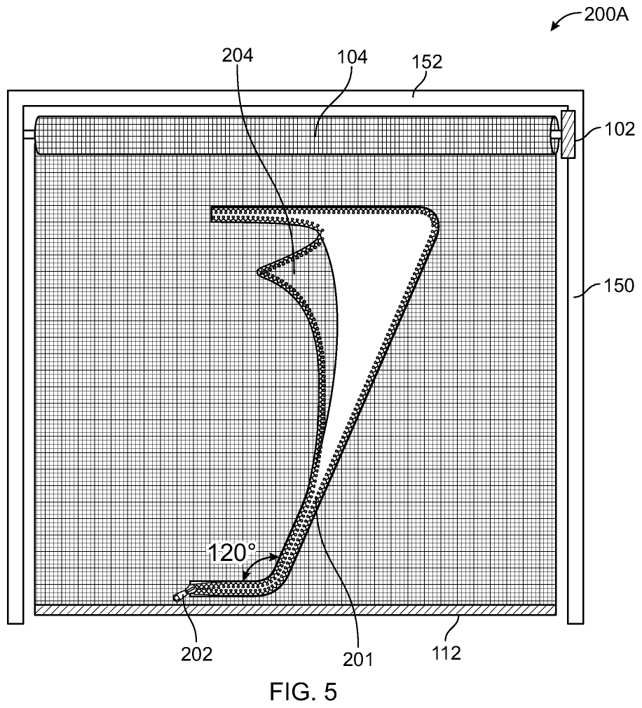

To enable the screen mesh 210 to properly wind around the spool when the screen mesh 210 is retracted (rolled onto the spool 104), the zipper structure 201/202 is configured so that, on the spool 104, there is no overlap of the zipper teeth 201. This configuration allows the screen mesh 210 to wrap properly around the spool 104 without overlap of the zipper teeth 201 based upon the angle of the zipper teeth 201 (e.g., 120 degrees as shown in FIGS. 4 and 5) with respect to the diameter of the spool 104 and the screen mesh 210 when that section of the zipper teeth 201 wind around the spool 104. For example, if the angle was closer to perpendicular, with one revolution of the spool 104, there will be overlap of the zipper teeth 201, causing an undesired thickness buildup that will lead to stretching and/or tearing the screen mesh 210 in an area around the zipper teeth 201. Also, by increasing a diameter of the spool 104, it is possible to decrease the angle (for example, decrease the angle to 110 degrees), though in no embodiments will the angle decrease to 90 degrees as 90 degrees will guarantee that the zipper teeth 201 will overlap when wound around the spool 104.

In this example, when the zipper pull 202 disengages the zipper teeth 201 from each other, a flap 204 of the screen door is lifted to gain asses (e.g., move into or out of the protected area).

As is shown in FIG. 3A, as the screen mesh 210 and the zipper teeth 201 wind around the spool 104, the thickness buildup of the zipper teeth 201 is evenly spread out over a wide area of the spool 104 and there is little or no overlap of the zipper teeth 201. Therefore, there is a bulge 105 caused by, for example, a single layer of the zipper teeth 201, that is not significant and will not deform the screen mesh 210.

Referring to FIGS. 4 and 5, elevational views of the screen system with a second layout of screen door 200A in the closed configuration in FIG. 4 and in the opened configuration in FIG. 5. The screen mesh 210 is shown in the deployed configuration in FIGS. 4 and 5 but retracts in a similar way (e.g., wound around the spool 104) as discussed above with FIG. 3A.

In such, the screen system with a second type of screen door 200A is shown deployed in FIGS. 4 and 5 and, therefore, the screen mesh 210 occludes the opening into which the screen system with a second type of screen door is installed (e.g., between garage door risers 150 on the sides, a garage door header 152 at the top and a floor of the garage at the bottom). When the screen system 200 is deployed, entry (or exit) of the protected area is provided by a door or opening formed in the screen mesh 210.

The screen mesh 210 is shown fully deployed from the spool 104 that is supported by a pin 106 at one end and a deployment mechanism 102 at an opposing end. The deployment mechanism is either a mechanical device (e.g., hand cranked) or an electro-mechanical device (e.g., motor driven).

When the screen mesh 210 is deployed, a mass 112 at an end of the screen mesh 210 reduces movement of the screen mesh 210 (e.g., when air movement occurs) and helps the screen mesh 210 roll up evenly on the spool 104 as the spool 104 rotates to retract (wind) the screen mesh 210.

To enable the screen mesh 210 to properly wrap around the spool when the screen mesh 210 is retracted (rolled onto the spool 104), the zipper structure 201/202 is configured so that, on the spool 104, there is minimal overlap of the zipper teeth 201. This configuration allows the screen mesh 210 to wind properly around the spool 104 without several layers of overlap of the zipper teeth 201 based upon the angle of the zipper teeth 201 (e.g., 120 degrees as shown in FIGS. 3 and 4) with respect to the diameter of the spool 104 and the screen mesh 210 when that section of the zipper teeth 201 wind around the spool 104. For example, if the angle was closer to perpendicular, with one revolution of the spool 104, there will be overlap of the zipper teeth 201, causing an undesired thickness buildup that will lead to stretching and/or tearing the screen mesh 210 in an area around the zipper teeth 201. Also, by increasing a diameter of the spool 104, it is possible to decrease the angle (e.g., decrease the angle to 110 degrees), though in no embodiments will the angle decrease to 90 degrees as a 90-degree angle will guarantee that the zipper teeth 201 will overlap when wound around the spool 104. Note that in this example, there is a horizontal segment of zipper teeth 201 and there will be at most two layers of zipper teeth 201 in the bulge 105 which is acceptable. In this example, there is a top section and bottom section of zipper teeth 201 that run substantially horizontal and a side section of zipper teeth 201 that connect the top section and bottom section of zipper teeth and run at approximately a 120-degree angle from horizontal. Further, in some embodiments, the distance between the horizontal segments of the zipper teeth 201 is configured such that when the horizontal segments of the zipper teeth 201 are wound around the spool 104, the horizontal segments of the zipper teeth 201 do not overlap, preferably winding up on opposite sides of the spool 104.

As is shown in FIG. 3A, as the screen mesh 210 and the zipper teeth 201 wrap around the spool 104, the thickness buildup of the zipper teeth 201 is evenly spread out over a wide area of the spool 104 and there is little or no overlap of the zipper teeth 201. Therefore, there is only a bulge 105 caused by, for example, a single layer of the zipper teeth 201, that is not significant and will not deform the screen mesh 210.

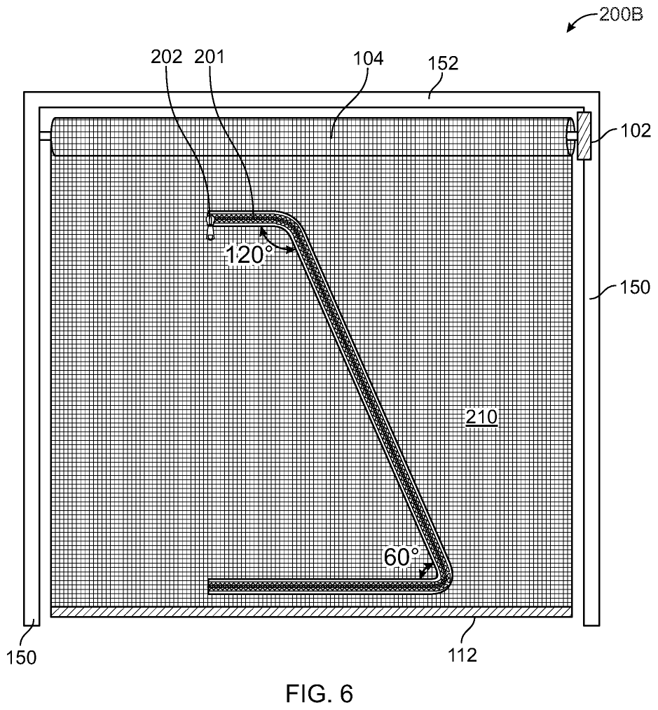

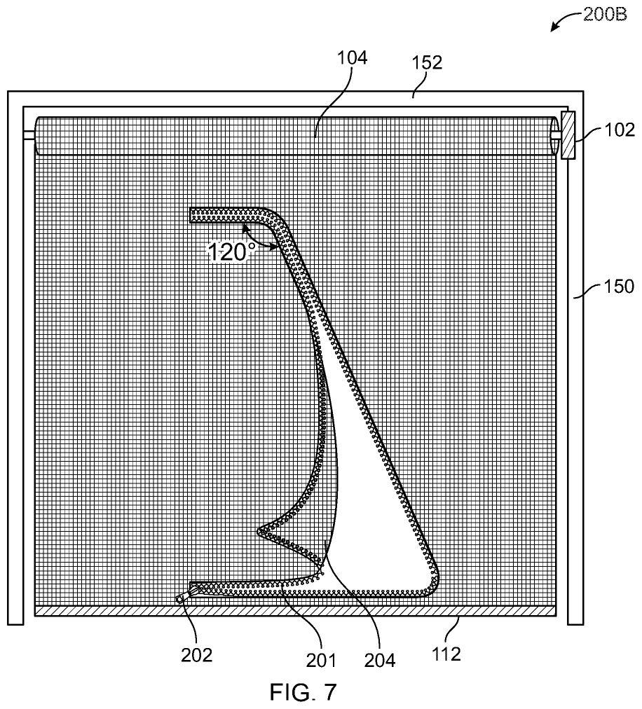

Referring to FIGS. 6 and 7, elevational views of the screen system with a third layout of screen door 200B in the closed configuration in FIG. 6 and in the opened configuration in FIG. 7. The screen mesh 210 is shown in the deployed configuration in FIGS. 6 and 7 but retracts in a similar way (e.g., wound around the spool 104) as discussed above with FIG. 3A.

In such, the screen system with a second type of screen door 200B is shown deployed in FIGS. 6 and 7 and, therefore, the screen mesh 210 occludes the opening into which the screen system with a second type of screen door is installed (e.g., between garage door risers 150 on the sides, a garage door header 152 at the top and a floor of the garage at the bottom). When the screen system 200B is deployed, entry (or exit) of the protected area is provided by a door or opening formed in the screen mesh 210.

The screen mesh 210 is shown fully deployed from the spool 104 that is supported by a pin 106 at one end and a deployment mechanism 102 at an opposing end. The deployment mechanism is either a mechanical device (e.g., hand cranked) or an electro-mechanical device (e.g., motor driven).

When the screen mesh 210 is deployed, a mass 112 at an end of the screen mesh 210 reduces movement of the screen mesh 210 (e.g., when air movement occurs) and helps the screen mesh 210 roll up evenly on the spool 104 as the spool 104 rotates to retract (wind) the screen mesh 210.

To enable the screen mesh 210 to properly wrap around the spool when the screen mesh 210 is retracted (rolled onto the spool 104), the zipper structure 201/202 is configured so that, on the spool 104, there is minimal overlap of the zipper teeth 201. This configuration allows the screen mesh 210 to wind properly around the spool 104 without several layers of overlap of the zipper teeth 201 based upon the angle of the zipper teeth 201 (e.g., 120 degrees as shown in FIGS. 3 and 4) with respect to the diameter of the spool 104 and the screen mesh 210 when that section of the zipper teeth 201 wind around the spool 104. For example, if the angle was closer to perpendicular, with one revolution of the spool 104, there will be overlap of the zipper teeth 201, causing an undesired thickness buildup that will lead to stretching and/or tearing the screen mesh 210 in an area around the zipper teeth 201. Also, by increasing a diameter of the spool 104, it is possible to decrease the angle (e.g., decrease the angle to 110 degrees), though in no embodiments will the angle decrease to 90 degrees as a 90-degree angle will guarantee that the zipper teeth 201 will overlap when wound around the spool 104. Note that in this example, there is a horizontal segment of zipper teeth 201 and there will be at most two layers of zipper teeth 201 in the bulge 105 which is acceptable. In this example, there is a top segment and bottom segment of zipper teeth 201 that run substantially horizontal and a side segment of zipper teeth 201 that connect the top segments and bottom segments of zipper teeth and run at approximately a 120-degree angle from horizontal.

In this example, when the zipper pull 202 disengages the zipper teeth 201 from each other, a flap 204 of the screen door is lifted to gain access (e.g., move into or out of the protected area).

Note that the zipper teeth 201 are affixed to the screen mesh 210 in any way known in the art, including, but not limited to, stitching, adhesive, ultrasonic welding, double-sided tape.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

The invention claimed is:

1. A screen system comprising:
a screen mesh for protecting an opening;
a spool, the spool rotatably mounted to a frame of the opening in a horizontal direction, the screen mesh affixed to the spool such that the spool selectively retracts the screen mesh from the opening by rotating in a first rotational direction or deploys the screen mesh over the opening by rotating in a second rotational direction that is opposite to the first rotational direction;
a mechanism for turning the spool to selectively retract or deploy the screen mesh;
a screen door that is formed in the screen mesh, sides of the screen door being at an angle other than 90 degrees to the spool; and
zipper teeth around a periphery of the screen door and the opening for the screen door such that a zipper pull traverses the zipper teeth in a first direction to disconnect the screen door from the opening for gaining access to/from the opening and the zipper pull traverses the zipper teeth in a second direction, opposing the first direction, for closing the screen door.

2. The screen system of claim 1, whereas at least a portion of the zipper teeth are at a 120-degree angle with respect to the horizontal direction.

3. The screen system of claim 1, whereas the zipper teeth form a flattened-V shape, a bottom of the flattened-V shape in the horizontal direction and sides of the flattened-V shape are at a 120-degree angles with respect to the bottom.

4. The screen system of claim 1, whereas the zipper teeth have a top segment and a bottom segment that are in the horizontal direction and a side segment that connects to the top segment and the bottom segment at a 120-degree angle.

5. The screen system of claim 1, further comprising a mass affixed to the screen mesh at an edge that is distal from the spool.

6. The screen system of claim 1, wherein the mechanism for turning the spool is an electric motor.

7. The screen system of claim 1, wherein the mechanism for turning the spool is a manually operated crank.

8. A screen system for protecting an area framed by a header that runs horizontal to earth, a first riser at a first end of the header that runs substantially perpendicular to the header and second riser at a second, opposite end of the header that also runs substantially perpendicular to the header, the screen system comprising:
a screen mesh for protecting the area;
a spool, the spool rotatably mounted between the first riser and the second riser parallel to the header, the screen mesh affixed to the spool such that rotating of the spool selectively retracts the screen mesh by rotating in a first rotational direction or deploys the screen mesh by rotating in a second rotational direction that is opposite to the first rotational direction;
a motor interfaced between either of the first riser or the second riser and the spool, the motor for rotating the spool;
a screen door that is formed in the screen mesh, sides of the screen door being at an angle other than 90 degrees to the header;
zipper teeth around a periphery of the screen door and opening for the screen door such that a zipper pull traverses the zipper teeth in a first direction to disconnect the screen door from the opening for gaining access to/from the opening and the zipper pull traverses the zipper teeth in a second direction, opposing the first direction, for closing the screen door; and
whereas the motor deploys the screen mesh by selectively rotating the spool in a first rotational direction and the motor retracts the screen mesh by selectively rotating the spool in a second rotational direction that is opposite of the first rotational direction.

9. The screen system of claim 8, whereas at least a portion of the zipper teeth are at a 120-degree angle with respect to the header.

10. The screen system of claim 8, whereas the zipper teeth form a flattened-V shape, a bottom of the flattened-V shape parallel to the header and sides of the flattened-V shape are at a 120-degree angles with respect to the header.

11. The screen system of claim 8, whereas the zipper teeth have a top segment and a bottom segment that are parallel to the header and a side segment that connects to the top segment and the bottom segment at a 120-degree angle.

12. The screen system of claim 11, whereas the top segment is at a distance from the bottom segment, the distance is set such that, when the screen mesh is retracted, the top segment and the bottom segment are not aligned at the same rotational location of the spool.

13. The screen system of claim 8, further comprising a mass affixed to the screen mesh at an edge that is distal from the spool.

14. A screen system for protecting a garage opening, the garage opening framed by a header that runs horizontal to earth, a first riser at a first end of the header that runs substantially perpendicular to the header and second riser at a second, opposite end of the header that also runs substantially perpendicular to the header, the screen system comprising:
a screen mesh for protecting the garage opening;
a spool, the spool rotatably mounted between the first riser and the second riser parallel to and adjacent to the header, the screen mesh affixed to the spool such that rotating of the spool selectively retracts the screen mesh by rotating in a first rotational direction or deploys the screen mesh by rotating in a second rotational direction that is opposite to the first rotational direction;
a motor interfaced between either of the first riser or the second riser and the spool, the motor for rotating the spool;
a screen door that is formed in the screen mesh, sides of the screen door being at an angle other than 90 degrees to the header;
zipper teeth around a periphery of the screen door and opening for the screen door such that a zipper pull traverses the zipper teeth in a first direction to disconnect the screen door from the opening for gaining access to/from the opening and the zipper pull traverses the zipper teeth in a second direction, opposing the first direction, for closing the screen door; and
whereas the motor deploys the screen mesh by selectively rotating the spool in a first rotational direction and the motor retracts the screen mesh by selectively rotating the spool in a second rotational direction that is opposite of the first rotational direction.

15. The screen system of claim 14, whereas at least a portion of the zipper teeth are at a 120-degree angle with respect to the header.

16. The screen system of claim 14, whereas the zipper teeth form a flattened-V shape, a bottom of the flattened-V shape parallel to the header and sides of the flattened-V shape are at a 120-degree angles with respect to the header.

17. The screen system of claim 14, whereas the zipper teeth have a top segment and a bottom segment that are parallel to the header and a side segment that connects to the top segment and the bottom segment at a 120-degree angle.

18. The screen system of claim 14, further comprising a mass affixed to the screen mesh at an edge that is distal from the spool.
